(19) United States
(12) Patent Application Publication
(10) Pub. No.: US 2026/0046907 A1
(43) Pub. Date: Feb. 12, 2026

(54) SYSTEMS, METHODS, AND DEVICES FOR SIDELINK UNLICENSED CHANNEL OCCUPATION TIME SHARING

(71) Applicant: Apple Inc., Cupertino, CA (US)

(72) Inventors: Huaning Niu, San Jose, CA (US); Wei Zeng, Saratoga, CA (US); Chunxuan Ye, San Diego, CA (US); Ankit Bhamri, Haar (DE); Dawei Zhang, Saratoga, CA (US); Haitong Sun, Saratoga, CA (US); Weidong Yang, San Diego, CA (US); Hong He, San Jose, CA (US); Sigen Ye, San Diego, CA (US); Seyed Ali Akbar Fakoorian, San Diego, CA (US)

(21) Appl. No.: 19/102,470

(22) PCT Filed: Aug. 2, 2023
(86) PCT No.: PCT/US23/29286

§ 371 Date: Feb. 10, 2025

Related U.S. Application Data
(60) Provisional application No. 63/397,472, filed on Aug. 12, 2022.

(51) Int. Cl. H04W 72/40; H04W 74/08; H04W 92/18

(52) U.S. Cl. CPC H04W 72/40; H04W 74/08; H04W 92/18

(57) ABSTRACT

The techniques described herein include solutions for signal timing and gaps for sidelink (SL) communications in the unlicensed spectrum (SL-U) within channel occupancy time (COT) sharing scenarios. Cyclic prefix (CP) extensions may be used to implement appropriate signal timing and gaps. Also described herein are types of signals (e.g., unicast, broadcast, multicast, and groupcast) and channels (e.g., physical SL shared channel (PSSCH), physical SL control channel (PSCCH), and physical SL feedback channel) that may be used in SL-U COT sharing scenarios, and solutions for transmission power thresholds for SL-U COT sharing scenarios.

### REFERENCE TO RELATED APPLICATIONS

The application claims the benefit of U.S. Provisional Patent Application 63/397,472 filed Aug. 12, 2022, entitled “SYSTEMS, METHODS, AND DEVICES FOR SIDELINK UNLICENSED CHANNEL OCCUPATION TIME SHARING”, the contents of which are herein incorporated by reference in their entirety.

### FIELD

This disclosure relates to wireless communication networks and mobile device capabilities.

### BACKGROUND

Wireless communication networks and wireless communication services are becoming increasingly dynamic, complex, and ubiquitous. For example, some wireless communication networks may be developed to implement fifth generation (5G) or new radio (NR) technology, sixth generation (6G) technology, and so on. Such technology may include solutions for enabling user equipment (UE) to communicate with one another directly.

### BRIEF DESCRIPTION OF THE DRAWINGS

The present disclosure will be readily understood and enabled by the detailed description and accompanying figures of the drawings. Like reference numerals may designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and may mean at least one, one or more, etc.

FIG. 1 is a diagram of an example overview according to one or more implementations described herein.

FIG. 2 is a diagram of an example network according to one or more implementations described herein.

FIGS. 3-5 are diagrams of examples of gap lengths for sidelink (SL) unlicensed (SL-U) channel occupation time (COT) sharing according to one or more implementations described herein.

FIGS. 6-11 are diagrams of examples of transmission signals for SL-U COT sharing according to one or more implementations described herein.

FIGS. 12-14 are diagrams of examples of configuring transmission power thresholds for SL-U COT sharing according to one or more implementations described herein.

FIG. 15 is a diagram of an example process for SL-U COT sharing according to one or more implementations described herein.

FIG. 16 is a diagram of an example process for configuring transmitting power thresholds for SL-U COT sharing according to one or more implementations described herein.

FIG. 17 a diagram of example interfaces of baseband circuitry according to one or more implementations described herein.

FIG. 18 is a block diagram illustrating components, according to one or more implementations described herein, able to read instructions from a machine-readable or computer-readable medium (e.g., a non-transitory machine-readable storage medium) and perform any one or more of the methodologies discussed herein.

### DETAILED DESCRIPTION

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

Wireless networks may include user equipment (UEs) capable of communicating with base stations, wireless routers, satellites, and other network nodes. Such devices may operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Internet-of-Things (IoT) devices (or IoT UEs) may utilize one or more types of communication technologies, such as proximity-based service (ProSe) or device-to-device (D2D) communications, vehicle-to-anything (V2X) communications, sidelink (SL) communications, and more.

SL communications, as described herein, may include a scenario in which a UE operates to discover, establish a connection, and communicate, with one or more other UEs via SL (e.g., a D2D communication). Examples of such devices may include a smartphone, a capable vehicle, and/or another type of UE or IoT device. A UE, as described herein, may refer to a smartphone, tablet device, wearable wireless device, a vehicle capable of V2X communications, a portion of a vehicle capable V2X communications, and/or another type of wireless-capable device. SL communications using the unlicensed wireless spectrum may be referred to a SL-U communications.

SL-U communications may include one or more channels. The channel used in an SL communication may be based on a dynamic grant (DG) or configured grant (CG) provided to a UE by the network. The channel may also be based on a channel selection by the UE itself (e.g., based on a UE-selected resource and pre-configuration). The DG or CG may include, or also be provided with, SL or wireless resource configuration information, such one or more channels and a channel occupancy time (COT). COT may refer to an amount of time that the UE may use a channel for SL communications. A COT may include an amount of time that the UE may use a channel for SL communications. In some implementations, the UE with the grant may contact another UE, and the UEs may use the same channel to communicate with one another. In such a scenario, the UEs may be said to have a shared COT. In some implementations, a COT may expire in response to one or more events, such as a UE receiving an SL signal but failing to respond according to a timing schedule (e.g., prior to expiration of a gap duration that is measured from after the signal was received). The base station may also, or alternatively, provide the UE with a maximum COT (MCOT), which may indicate a maximum amount of time the UE may use the channel for SL communications. The MCOT can also be determined by the UE's choice of channel access priority class (CAPC) for channel access procedure. The DG or CG may end if/when the COT or the MCOT expires. Some current SL techniques may fail to provide adequate communication standards for enabling direct communication between UEs in SL-U COT sharing scenarios. For example, currently available SL techniques fail to establish clear signal timing standards for SL-U COT sharing, types of signaling and channels for SL-U COT sharing scenarios, transmission power thresholds for SL-U COT sharing scenarios, and more,

The techniques described herein provide solutions for enabling direct SL communications between UEs by overcoming the deficiencies of the currently available techniques. For example, the techniques described herein include solutions for signal timing and gaps for SL-U COT sharing for different clear channel assessment (CCA) types. In some implementations, cyclic prefix (CP) extensions may be used to implement appropriate signal timing and gaps. Also described herein are types of signals (e.g., unicast, broadcast, multicast, and groupcast) and channels (e.g., physical SL shared channel (PSSCH), physical SL control channel (PSCCH), and physical SL feedback channel (PSFCH)) that may be used in SL-U COT sharing scenarios, and solutions for transmission power thresholds for SL-U COT sharing scenarios.

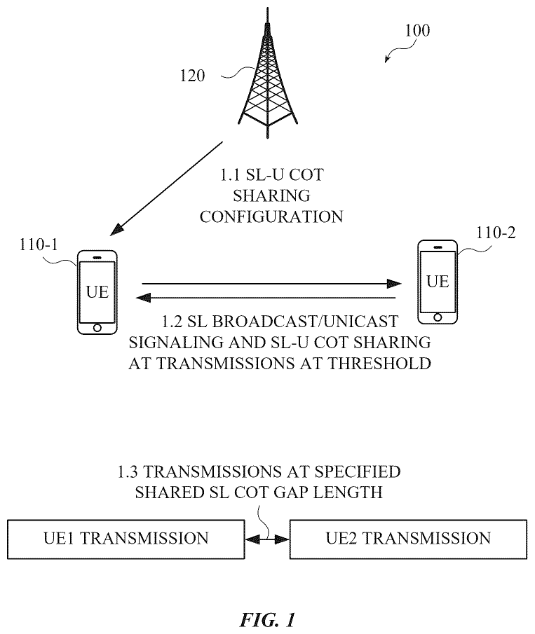

FIG. 1 is a diagram of an example overview 100 according to one or more implementations described herein. As shown, overview 100 may include UE 110-1, UE 110-2, and base station 120. Base station 120 may provide UE 110-1 with an SL grant to enable UE 110-1 to establish an SL connection with one or more UEs (e.g., UE 110-2) (at 1.1). The SL grant, and/or other types of configuration information, may include an SL-U COT sharing configuration.

The SL-U COT sharing configuration may indicate types of communication gaps permitted between SL communications, types of signals permitted for SL communications permitted (e.g., unicast, broadcast, multicast, and groupcast), maximum power transmission thresholds permitted, and more. UE 110-1 may initiate an SL connection with UE 110-2, which may include UE 110-1 sharing some or all of the SL-U COT sharing information with UE 110-2, and UE 110-2 responding in kind (at 1.2). In some implementations, SL-U COT sharing and gap information may also, or alternatively, be received via sidelink control information (SCI) (stage 1) and may not involve a grant from base station 120. For example, UE 110-1 may send UE 110-2 SL-U COT sharing information via a PSCCH. In some implementations, providing or enabling an SL-U COT sharing configuration in this manner may be beneficial in mode 1 and 2 CG scenarios where downlink (DL) control information (DCI is not used before each transmission.

As shown in FIG. 1, communications between UE 110-1 and UE 110-2 may be in accordance with the gap configuration indicated by the SL-U COT sharing configuration (at 1.3). UE 110-1 and UE 110-2 may continue, or proceed, to communicate via SL communications to establish an SL connection and communicate thereafter in accordance with the SL-U COT sharing configuration. Additional features and details of these techniques are described below with reference to the Figures below.

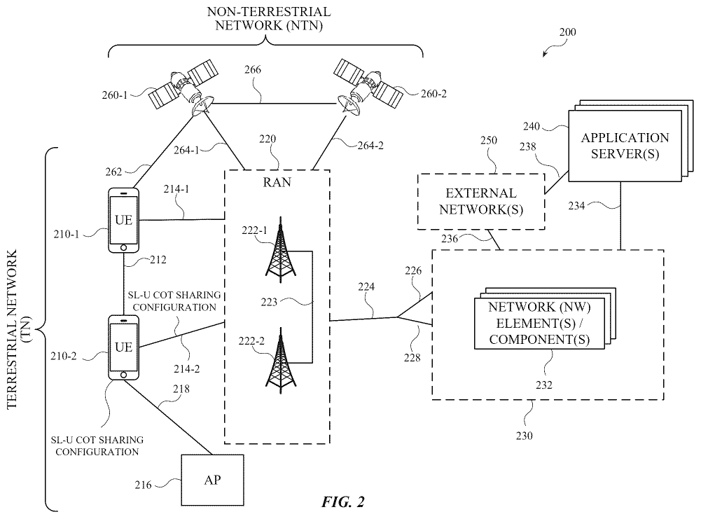

FIG. 2 is an example network 200 according to one or more implementations described herein. Example network 200 may include UEs 210-1, 210-2, etc. (referred to collectively as “UEs 210” and individually as “UE 210”), a radio access network (RAN) 220, a core network (CN) 230, application servers 240, external networks 250, and satellites 260-1, 260-2, etc. (referred to collectively as “satellites 260” and individually as “satellite 260”). As shown, network 200 may include a non-terrestrial network (NTN) comprising one or more satellites 260 (e.g., of a global navigation satellite system (GNSS)) in communication with UEs 210 and RAN 220.

The systems and devices of example network 200 may operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 200 may operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

As shown, UEs 210 may include smartphones (e.g., handheld touchscreen mobile computing devices connectable to one or more wireless communication networks). Additionally, or alternatively, UEs 210 may include other types of mobile or non-mobile computing devices capable of wireless communications, such as personal data assistants (PDAs), pagers, laptop computers, desktop computers, wireless handsets, etc. In some implementations, UEs 210 may include internet of things (IoT) devices (or IoT UEs) that may comprise a network access layer designed for low-power IoT applications utilizing short-lived UE connections. Additionally, or alternatively, an IoT UE may utilize one or more types of technologies, such as machine-to-machine (M2M) communications or machine-type communications (MTC) (e.g., to exchanging data with an MTC server or other device via a public land mobile network (PLMN)), proximity-based service (ProSe) or device-to-device (D2D) communications, sensor networks, IoT networks, and more. Depending on the scenario, an M2M or MTC exchange of data may be a machine-initiated exchange, and an IoT network may include interconnecting IoT UEs (which may include uniquely identifiable embedded computing devices within an Internet infrastructure) with short-lived connections. In some scenarios, IoT UEs may execute background applications (e.g., keep-alive messages, status updates, etc.) to facilitate the connections of the IoT network.

UEs 210 may communicate and establish a connection with one or more other UEs 210 via one or more wireless channels 212, each of which may comprise a physical communications interface/layer. The connection may include an M2M connection, MTC connection, D2D connection, etc. In some implementations, UEs 210 may be configured to discover one another, negotiate wireless resources between one another, and establish connections between one another, without intervention or communications involving RAN node 222 or another type of network node. In some implementations, discovery, authentication, resource negotiation, registration, etc., may involve communications with RAN node 222 or another type of network node.

UEs 210 may use one or more wireless channels 212 to communicate with one another. As described herein, UE 210-1 may communicate with RAN node 222 to request SL resources. RAN node 222 may respond to the request by providing UE 210 with a dynamic grant (DG) or configured grant (CG) regarding SL resources. UE 210 may perform a clear channel assessment (CCA) procedure based on the DG or CG, select SL resources based on the CCA procedure and the DG or CG; and communicate with another UE 210 based on the SL resources. The UE 210 may communicate with RAN node 222 using a licensed frequency band and communicate with the other UE 210 using an unlicensed frequency band.

UEs 210 may communicate and establish a connection with (e.g., be communicatively coupled) with RAN 220, which may involve one or more wireless channels 214-1 and 214-2, each of which may comprise a physical communications interface/layer. In some implementations, a UE may be configured with dual connectivity (DC) as a multi-radio access technology (multi-RAT) or multi-radio dual connectivity (MR-DC), where a multiple receive and transmit (Rx/Tx) capable UE may use resources provided by different network nodes (e.g., 222-1 and 222-2) that may be connected via non-ideal backhaul (e.g., where one network node provides NR access and the other network node provides either E-UTRA for LTE or NR access for 5G). In such a scenario, one network node may operate as a master node (MN) and the other as the secondary node (SN). The MN and SN may be connected via a network interface, and at least the MN may be connected to the CN 230. Additionally, at least one of the MN or the SN may be operated with shared spectrum channel access, and functions specified for UE 210 can be used for an integrated access and backhaul mobile termination (IAB-MT). Similar for UE 210, the IAB-MT may access the network using either one network node or using two different nodes with enhanced dual connectivity (EN-DC) architectures, new radio dual connectivity (NR-DC) architectures, or the like. In some implementations, a base station (as described herein) may be an example of network node 222.

As described herein, UE 210 may receive an SL grant from RAN node 222. The SL grant and/or other configuration information received from RAN node 222 may specify SL signal timing and gaps for SL-U COT sharing with one or more other UEs 210. RAN node 222 may also provide UE 210 with information and instructions regarding types of signals (e.g., unicast, broadcast, and groupcast signals) and channels (e.g., PSFCH, PSSCH, and PSCCH) that may be used in SL-U COT sharing scenarios. UE 210 may also receive configuration information about maximum transmission power thresholds that UE 210 may use for SL-U COT sharing scenarios.

As shown, UE 210 may also, or alternatively, connect to access point (AP) 216 via connection interface 218, which may include an air interface enabling UE 210 to communicatively couple with AP 216. AP 216 may comprise a wireless local area network (WLAN), WLAN node, WLAN termination point, etc. The connection 216 may comprise a local wireless connection, such as a connection consistent with any IEEE 702.11 protocol, and AP 216 may comprise a wireless fidelity (Wi-Fi®) router or other AP. While not explicitly depicted in FIG. 2, AP 216 may be connected to another network (e.g., the Internet) without connecting to RAN 220 or CN 230. In some scenarios, UE 210, RAN 220, and AP 216 may be configured to utilize LTE-WLAN aggregation (LWA) techniques or LTE WLAN radio level integration with IPsec tunnel (LWIP) techniques. LWA may involve UE 210 in RRC_CONNECTED being configured by RAN 220 to utilize radio resources of LTE and WLAN. LWIP may involve UE 210 using WLAN radio resources (e.g., connection interface 218) via IPsec protocol tunneling to authenticate and encrypt packets (e.g., Internet Protocol (IP) packets) communicated via connection interface 218. IPsec tunneling may include encapsulating the entirety of original IP packets and adding a new packet header, thereby protecting the original header of the IP packets.

RAN 220 may include one or more RAN nodes 222-1 and 222-2 (referred to collectively as RAN nodes 222, and individually as RAN node 222) that enable channels 214-1 and 214-2 to be established between UEs 210 and RAN 220. RAN nodes 222 may include network access points configured to provide radio baseband functions for data and/or voice connectivity between users and the network based on one or more of the communication technologies described herein (e.g., 2G, 3G, 4G, 5G, WiFi, etc.). As examples therefore, a RAN node may be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 222 may include a roadside unit (RSU), a transmission reception point (TRxP or TRP), and one or more other types of ground stations (e.g., terrestrial access points). In some scenarios, RAN node 222 may be a dedicated physical device, such as a macrocell base station, and/or a low power (LP) base station for providing femtocells, picocells or the like having smaller coverage areas, smaller user capacity, or higher bandwidth compared to macrocells. As described below, in some implementations, satellites 260 may operate as bases stations (e.g., RAN nodes 222) with respect to UEs 210. As such, references herein to a base station, RAN node 222, etc., may involve implementations where the base station, RAN node 222, etc., is a terrestrial network node and to implementation where the base station, RAN node 222, etc., is a non-terrestrial network node (e.g., satellite 260).

Some or all of RAN nodes 222, or portions thereof, may be implemented as one or more software entities running on server computers as part of a virtual network, which may be referred to as a centralized RAN (CRAN) and/or a virtual baseband unit pool (vBBUP). In these implementations, the CRAN or vBBUP may implement a RAN function split, such as a packet data convergence protocol (PDCP) split wherein radio resource control (RRC) and PDCP layers may be operated by the CRAN/vBBUP and other Layer 2 (L2) protocol entities may be operated by individual RAN nodes 222; a media access control (MAC)/physical (PHY) layer split wherein RRC, PDCP, radio link control (RLC), and MAC layers may be operated by the CRAN/vBBUP and the PHY layer may be operated by individual RAN nodes 222; or a “lower PHY” split wherein RRC, PDCP, RLC, MAC layers and upper portions of the PHY layer may be operated by the CRAN/vBBUP and lower portions of the PHY layer may be operated by individual RAN nodes 222. This virtualized framework may allow freed-up processor cores of RAN nodes 222 to perform or execute other virtualized applications.

In some implementations, an individual RAN node 222 may represent individual gNB-distributed units (DUs) connected to a gNB-control unit (CU) via individual F1 or other interfaces. In such implementations, the gNB-DUs may include one or more remote radio heads or radio frequency (RF) front end modules (RFEMs), and the gNB-CU may be operated by a server (not shown) located in RAN 220 or by a server pool (e.g., a group of servers configured to share resources) in a similar manner as the CRAN/vBBUP. Additionally, or alternatively, one or more of RAN nodes 222 may be next generation eNBs (i.e., gNBs) that may provide evolved universal terrestrial radio access (E-UTRA) user plane and control plane protocol terminations toward UEs 210, and that may be connected to a 5G core network (5GC) 230 via an NG interface.

Any of the RAN nodes 222 may terminate an air interface protocol and may be the first point of contact for UEs 210. In some implementations, any of the RAN nodes 222 may fulfill various logical functions for the RAN 220 including, but not limited to, radio network controller (RNC) functions such as radio bearer management, uplink and downlink dynamic radio resource management and data packet scheduling, and mobility management. UEs 210 may be configured to communicate using orthogonal frequency-division multiplexing (OFDM) communication signals with each other or with any of the RAN nodes 222 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or sidelink (SL) communications), although the scope of such implementations may not be limited in this regard. The OFDM signals may comprise a plurality of orthogonal subcarriers.

In some implementations, a downlink resource grid may be used for downlink transmissions from any of the RAN nodes 222 to UEs 210, and uplink transmissions may utilize similar techniques. The grid may be a time-frequency grid (e.g., a resource grid or time-frequency resource grid) that represents the physical resource for downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises resource blocks, which describe the mapping of certain physical channels to resource elements. Each resource block may comprise a collection of resource elements (REs); in the frequency domain, this may represent the smallest quantity of resources that currently may be allocated. There are several different physical downlink channels that are conveyed using such resource blocks.

Further, RAN nodes 222 may be configured to wirelessly communicate with UEs 210, and/or one another, over a licensed medium (also referred to as the “licensed spectrum” and/or the “licensed band”), an unlicensed shared medium (also referred to as the “unlicensed spectrum” and/or the “unlicensed band”), or combination thereof. In an example, a licensed spectrum may include channels that operate in the frequency range of approximately 400 MHz to approximately 3.8 GHz, whereas the unlicensed spectrum may include the 5 GHz band. A licensed spectrum may correspond to channels or frequency bands selected, reserved, regulated, etc., for certain types of wireless activity (e.g., wireless telecommunication network activity), whereas an unlicensed spectrum may correspond to one or more frequency bands that are not restricted for certain types of wireless activity. Whether a particular frequency band corresponds to a licensed medium or an unlicensed medium may depend on one or more factors, such as frequency allocations determined by a public-sector organization (e.g., a government agency, regulatory body, etc.) or frequency allocations determined by a private-sector organization involved in developing wireless communication standards and protocols, etc.

To operate in the unlicensed spectrum, UEs 210 and the RAN nodes 222 may operate using licensed assisted access (LAA), eLAA, and/or feLAA mechanisms. In these implementations, UEs 210 and the RAN nodes 222 may perform one or more known medium-sensing operations or carrier-sensing operations in order to determine whether one or more channels in the unlicensed spectrum is unavailable or otherwise occupied prior to transmitting in the unlicensed spectrum. The medium/carrier sensing operations may be performed according to a listen-before-talk (LBT) protocol.

The LAA mechanisms may be built upon carrier aggregation (CA) technologies of LTE-Advanced systems. In CA, each aggregated carrier is referred to as a component carrier (CC). In some cases, individual CCs may have a different bandwidth than other CCs. In time division duplex (TDD) systems, the number of CCs as well as the bandwidths of each CC may be the same for DL and UL. CA also comprises individual serving cells to provide individual CCs. The coverage of the serving cells may differ, for example, because CCs on different frequency bands will experience different pathloss. A primary service cell or PCell may provide a primary component carrier (PCC) for both UL and DL and may handle RRC and non-access stratum (NAS) related activities. The other serving cells are referred to as SCells, and each SCell may provide an individual secondary component carrier (SCC) for both UL and DL. The SCCs may be added and removed as required, while changing the PCC may require UE 210 to undergo a handover. In LAA, eLAA, and feLAA, some or all of the SCells may operate in the unlicensed spectrum (referred to as “LAA SCells”), and the LAA SCells are assisted by a PCell operating in the licensed spectrum. When a UE is configured with more than one LAA SCell, the UE may receive UL grants on the configured LAA SCells indicating different physical uplink shared channel (PUSCH) starting positions within a same subframe. To operate in the unlicensed spectrum, UEs 210 and the RAN nodes 222 may also operate using stand-alone unlicensed operation where the UE may be configured with a PCell, in addition to any SCells, in unlicensed spectrum.

The PDSCH may carry user data and higher layer signaling to UEs 210. The physical downlink control channel (PDCCH) may carry information about the transport format and resource allocations related to the PDSCH channel, among other things. The PDCCH may also inform UEs 210 about the transport format, resource allocation, and hybrid automatic repeat request (HARQ) information related to the uplink shared channel. Typically, downlink scheduling (e.g., assigning control and shared channel resource blocks to UE 210-2 within a cell) may be performed at any of the RAN nodes 222 based on channel quality information fed back from any of UEs 210. The downlink resource assignment information may be sent on the PDCCH used for (e.g., assigned to) each of UEs 210.

The PDCCH uses control channel elements (CCEs) to convey the control information, wherein several CCEs (e.g., 6 or the like) may consists of a resource element groups (REGs), where a REG is defined as a physical resource block (PRB) in an OFDM symbol.

Before being mapped to resource elements, the PDCCH complex-valued symbols may first be organized into quadruplets, which may then be permuted using a sub-block interleaver for rate matching, for example. Each PDCCH may be transmitted using one or more of these CCEs, where each CCE may correspond to nine sets of four physical resource elements known as REGs. Four quadrature phase shift keying (QPSK) symbols may be mapped to each REG. The PDCCH may be transmitted using one or more CCEs, depending on the size of the DCI and the channel condition. There may be four or more different PDCCH formats defined in LTE with different numbers of CCEs (e.g., aggregation level, L=1, 2, 4, 8, or 16).

Some implementations may use concepts for resource allocation for control channel information that are an extension of the above-described concepts. For example, some implementations may utilize an extended (E)-PDCCH that uses PDSCH resources for control information transmission. The EPDCCH may be transmitted using one or more ECCEs. Similar to the above, each ECCE may correspond to nine sets of four physical resource elements known as an EREGs. An ECCE may have other numbers of EREGs in some situations.

The RAN nodes 222 may be configured to communicate with one another via interface 223. In implementations where the system is an LTE system, interface 223 may be an X2 interface. In NR systems, interface 223 may be an Xn interface. The X2 interface may be defined between two or more RAN nodes 222 (e.g., two or more eNBs/gNBs or a combination thereof) that connect to evolved packet core (EPC) or CN 230, or between two eNBs connecting to an EPC. In some implementations, the X2 interface may include an X2 user plane interface (X2-U) and an X2 control plane interface (X2-C). The X2-U may provide flow control mechanisms for user data packets transferred over the X2 interface and may be used to communicate information about the delivery of user data between eNBs or gNBs. For example, the X2-U may provide specific sequence number information for user data transferred from a master eNB (MeNB) to a secondary eNB (SeNB); information about successful in sequence delivery of PDCP packet data units (PDUs) to a UE 210 from an SeNB for user data; information of PDCP PDUs that were not delivered to a UE 210; information about a current minimum desired buffer size at the SeNB for transmitting to the UE user data; and the like. The X2-C may provide intra-LTE access mobility functionality (e.g., including context transfers from source to target eNBs, user plane transport control, etc.), load management functionality, and inter-cell interference coordination functionality.

As shown, RAN 220 may be connected (e.g., communicatively coupled) to CN 230. CN 230 may comprise a plurality of network elements 232, which are configured to offer various data and telecommunications services to customers/subscribers (e.g., users of UEs 210) who are connected to the CN 230 via the RAN 220. In some implementations, CN 230 may include an evolved packet core (EPC), a 5G CN, and/or one or more additional or alternative types of CNs. The components of the CN 230 may be implemented in one physical node or separate physical nodes including components to read and execute instructions from a machine-readable or computer-readable medium (e.g., a non-transitory machine-readable storage medium). In some implementations, network function virtualization (NFV) may be utilized to virtualize any or all the above-described network node roles or functions via executable instructions stored in one or more computer-readable storage mediums (described in further detail below). A logical instantiation of the CN 230 may be referred to as a network slice, and a logical instantiation of a portion of the CN 230 may be referred to as a network sub-slice. Network Function Virtualization (NFV) architectures and infrastructures may be used to virtualize one or more network functions, alternatively performed by proprietary hardware, onto physical resources comprising a combination of industry-standard server hardware, storage hardware, or switches. In other words, NFV systems may be used to execute virtual or reconfigurable implementations of one or more EPC components/functions.

As shown, CN 230, application servers 240, and external networks 250 may be connected to one another via interfaces 234, 236, and 238, which may include IP network interfaces. Application servers 240 may include one or more server devices or network elements (e.g., virtual network functions (VNFs) offering applications that use IP bearer resources with CM 230 (e.g., universal mobile telecommunications system packet services (UMTS PS) domain, LTE PS data services, etc.). Application servers 240 may also, or alternatively, be configured to support one or more communication services (e.g., voice over IP (VOIP sessions, push-to-talk (PTT) sessions, group communication sessions, social networking services, etc.) for UEs 210 via the CN 230. Similarly, external networks 250 may include one or more of a variety of networks, including the Internet, thereby providing the mobile communication network and UEs 210 of the network access to a variety of additional services, information, interconnectivity, and other network features.

As shown, example network 200 may include an NTN that may comprise one or more satellites 260-1 and 260-2 (collectively, “satellites 260”). Satellites 260 may be in communication with UEs 210 via service link or wireless interface 262 and/or RAN 220 via feeder links or wireless interfaces 264 (depicted individually as 264-1 and 264-2). In some implementations, satellite 260 may operate as a passive or transparent network relay node regarding communications between UE 210 and the terrestrial network (e.g., RAN 220). In some implementations, satellite 260 may operate as an active or regenerative network node such that satellite 260 may operate as a base station to UEs 210 (e.g., as a gNB of RAN 220) regarding communications between UE 210 and RAN 220. In some implementations, satellites 260 may communicate with one another via a direct wireless interface (e.g., 266) or an indirect wireless interface (e.g., via RAN 220 using interfaces 264-1 and 264-2).

Additionally, or alternatively, satellite 260 may include a GEO satellite, LEO satellite, or another type of satellite. Satellite 260 may also, or alternatively pertain to one or more satellite systems or architectures, such as a global navigation satellite system (GNSS), global positioning system (GPS), global navigation satellite system (GLONASS), BeiDou navigation satellite system (BDS), etc. In some implementations, satellites 260 may operate as bases stations (e.g., RAN nodes 222) with respect to UEs 210. As such, references herein to a base station, RAN node 222, etc., may involve implementations where the base station, RAN node 222, etc., is a terrestrial network node and implementation, where the base station, RAN node 222, etc., is a non-terrestrial network node (e.g., satellite 260). As described herein, UE 210 and base station 222 may communicate with one another, via interface 214, to enable enhanced power saving techniques.

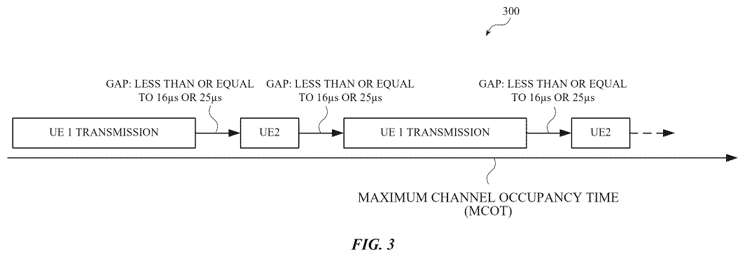

FIGS. 3-5 are diagrams of examples 300, 400, and 500 (referred to hereafter as examples 300-500) of gap lengths for SL-U COT sharing according to one or more implementations described herein. As shown, examples 300-500 each include representation of a MCOT allocated to resources for SL-U communications between UE1 and UE2. Additionally, examples 300-500 each include transmissions back and forth between UE1 and UE2 during the MCOT.

Referring to FIG. 3, each gap may include: 1) a gap that is less than 16 microseconds (μs), equal to 16 μs, or equal to 25 μs. In some implementations, no other gaps are allowed. For example, if a signal is received at any other time other than before 16 μs, at 16 μs, or at 25 μs. If not, the signal may be ignored and/or the SL-U COT may be ended, such that no further SL-U COT sharing is allowed, and a type 1 CCA procedure may be required to resume SL communications using the channel. A type 1 CCA procedure may include a DL channel access procedure, a UL channel access procedure, or a combination of a DL and UL channel access procedure.

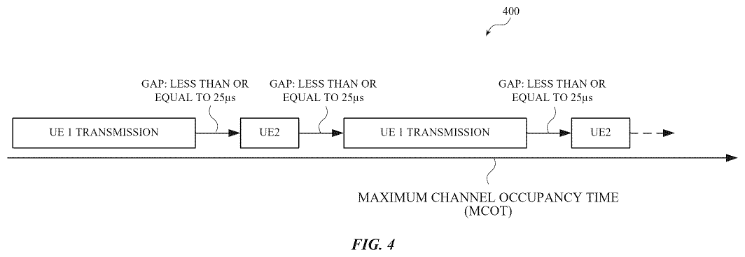

Referring to FIG. 4, each gap may include: 1) a gap that is less than 25 μs; or a gap that is equal to 25 μs. For any gap less than 16 μs may not involve or require a listen-before-talk (LBT) procedure to ensure the channel is clear for SL communications. For a gap that is greater or equal to 16 μs, and less or equal to 25 μs, a one shot LBT procedure may be used to ensure the channel is clear before resuming SL communications between UE1 and UE2. A one shot LBT procedure may include a procedure in which channel availability is determined one procedure at a time. A gap length greater than 25 μs may result in the SL-U COT sharing ending unless a type 1 CCA procedure is to resume SL communications using the channel.

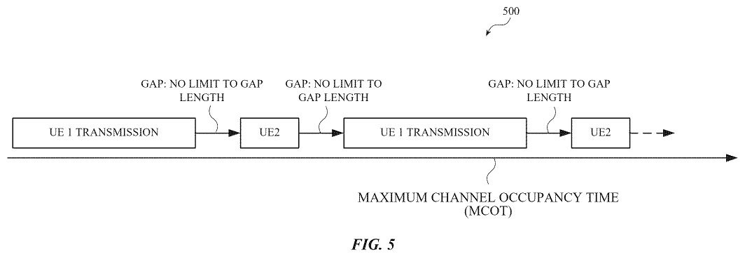

Referring to FIG. 5, any length of gap may be allowed. However, the gap lengths are counted into the MCOT, and when the MCOT expires then the COT and SL-U COT sharing may end. For a gap length that is less than 16 μs, no LBT may be performed to continue using the channel. For a gap length that is greater than or equal to 16 μs, a successful one shot LBT may be performed to continue using the channel.

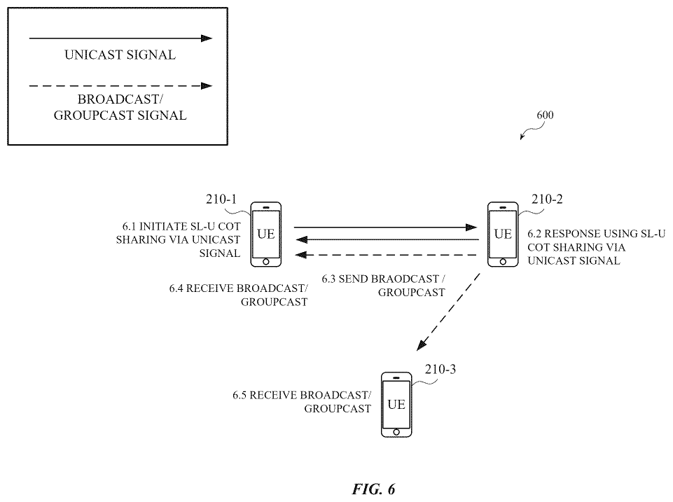

FIGS. 6-11 are diagrams of examples 600, 700, 800, 900, 1000, and 1100 (collectively referred to as examples 600-1100) of transmission signals and channels for SL-U COT sharing according to one or more implementations described herein. As shown, examples 600-1100 include SL communications between UE 210-1, 210-2, and/or 210-3. The SL communications may include unicast signals, broadcast signals, and/or groupcast signals. Unicast SL communications may be represented with a solid arrow; broadcast and/or groupcast signals may be represented with dashed arrows. Each of examples 600-1100 may be a non-limiting solution to standards and procedures for SL-U COT sharing among UEs 210. In examples 600-1100, a grant may be optional and/or may only be for mode 1 SL resource selection. For mode 1 DG, for example, a grant may be used before every transmission. For mode 1 CG, by contrast, either RRC configuration of resource, or RRC configuration of resource with DCI activation may be used. After configuration/activation, no grant may be needed before SL transmission, and transmission may be up to UE 210. For mode-2 SL resource selection, no grant may be needed.

Referring to FIG. 6, UE 210-1 may receive an SL grant (e.g., DG or CG) from base station 222 (not shown). UE 210-1 may initiate SL-U COT sharing via unicast signal to UE 210-2 (at 6.1). This may include a mode 1 SL resource selection procedure. In some implementations, UE 210-1 may perform a mode 2 SL resource selection procedure, which may include selecting SL resources itself (e.g., without a grant from base station 222). Initiating SL-U COT sharing may include providing another UE 210 with information that enables the UE 210 to engage in SL-U sharing. Examples of such information may include SCI stage 1 information, such as CP extension information, CCA type information, remaining COT length, transmission power, transmission power thresholds, etc. UE 210-1 may provide UE 210-2 with SCI (e.g., stage 1 SCI) which may include a CP extension and CCA type for COT sharing. The CP extension may be used to create an appropriate signaling gap between UE 210-1 and UE 210-2. In some implementations, only the receiving device of the paired unicast transmission (e.g., UE 210-2) may share the SL-U COT. As such, UE 210-2 may respond to UE 210-1 via unicast using the using the shared SL-U COT (at 6.2). The unicast signals may include a PSCCH, PSSCH, and/or a PSFCH.

UE 210-2 may also, or alternatively, send a control, broadcast or a groupcast signal to UE 210-1 and UE 210-3 (at 6.3), which may be received by both UE 210-1 and UE 210-3 (at 6.4 and 6.5). In some implementations, doing so is permitted so long as the broadcast or a groupcast signal includes information for the UE that initiated the SL-U COT sharing (e.g., 210-1), and/or only control/broadcast signals/channels transmissions of up to 2/4/8 OFDM symbols in duration for 15 kHz, 30 kHz, or 60 kHz subcarrier spacing.

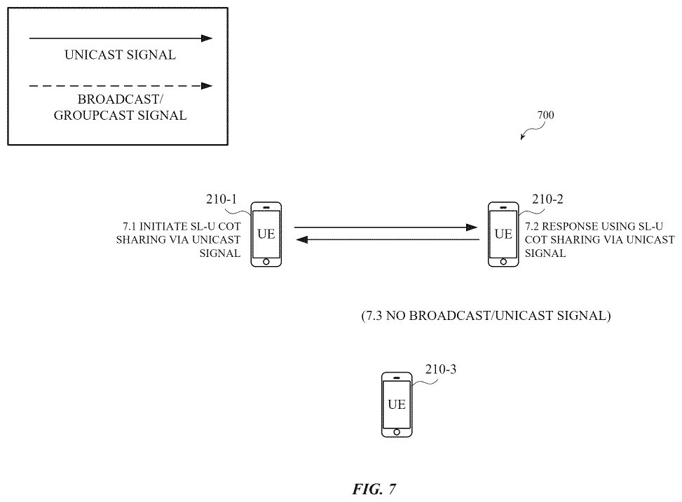

Referring to FIG. 7, UE 210-1 may receive an SL grant (e.g., DG or CG) from base station 222 (not shown). UE 210-1 may initiate SL-U COT sharing via unicast signal to UE 210-2n (at 7.1). In some implementations, only the receiving device of the paired unicast transmission (e.g., UE 210-2) may share the SL-U COT. As such, UE 210-2 may respond to UE 210-1 via unicast using the using the shared SL-U COT (at 7.2). The unicast signal may include a PSCCH, PSSCH, and/or a PSFCH. In contrast to example 600 of FIG. 6, in example 700 UE 210-2 may not send a broadcast or group cast message to other UEs 210s.

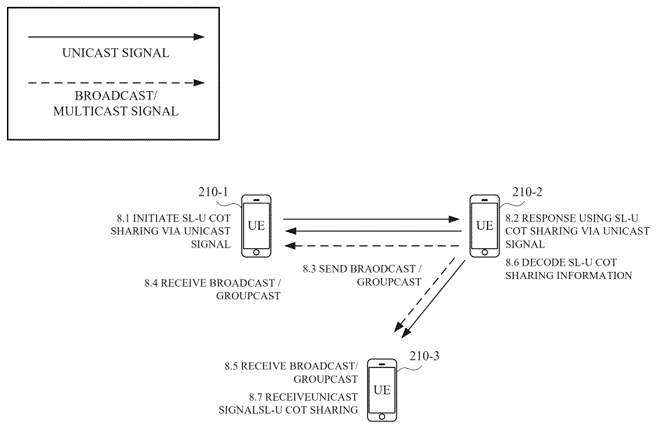

Referring to FIG. 8, UE 210-1 may receive an SL grant (e.g., DG or CG) from base station 222 (not shown). UE 210-1 may initiate SL-U COT sharing via unicast signal to UE 210-2 (at 8.1). UE 210-2 may respond to UE 210-1 via unicast using the using the shared SL-U COT (at 8.2). The unicast signals may include a PSCCH, PSSCH, and/or a PSFCH.

UE 210-2 may send a control, broadcast or a groupcast signal to UE 210-1 and UE 210-3 (at 8.3), which may be received by both UE 210-1 and UE 210-3 (at 6.4 and 6.5). In some implementations, doing so may be permitted so long as the broadcast or a groupcast signal includes information for the UE that initiated the SL-U COT sharing (e.g., 210-1), and/or only control/broadcast signals/channels transmissions of up to 2/4/8 OFDM symbols in duration for 15 kHz, 30 kHz, or 60 kHz subcarrier spacing.

In some implementations, UEs (e.g., UE 210-2) may can decode the control information (e.g., stage 1 SL control information (SCI) with the CCA type for COT), included in the COT sharing information, to acquire and share the COT sharing information for SL transmissions (at 8.6). As such, UE 210-2 may use the SCI to send a unicast signal to UE 210-3 in accordance with the shared SL-U COT (at 8.7). The unicast signals may include a PSCCH, PSSCH, and/or a PSFCH. In some implementations, this may enable UE 210-3 to, for example, respond to UE 210-2 via a unicast signal in accordance with the shared SL-U COT (not shown).

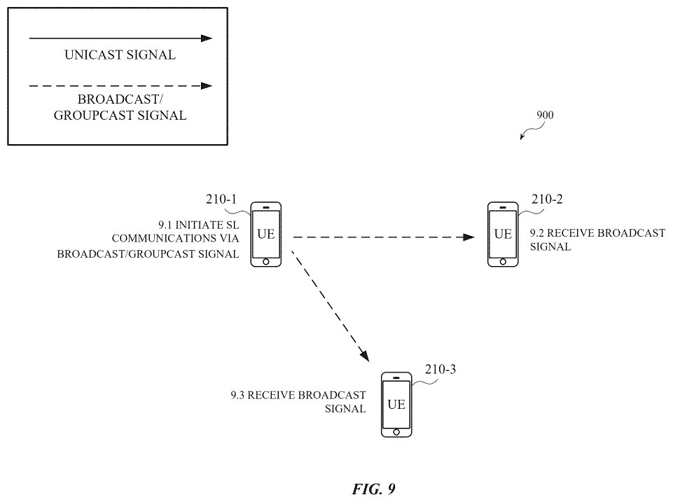

Referring to FIG. 9, UE 210-1 may receive an SL grant (e.g., DG or CG) from base station 222 (not shown). UE 210-1 may broadcast or groupcast one or more signals to UEs 210-2 and 210-3 (9.1). UEs 210-2 and 210-3 may receive the broadcast or groupcast signals (at 9.2 and 9.3) and the signals may be used to initiate SL communications between UEs 210. However, the broadcast or groupcast signals may not initiate SL-U COT sharing between the UEs 210. Instead, UEs 210-2 and 210-3 may respond by performing type 1 CCA and acquiring the COT itself.

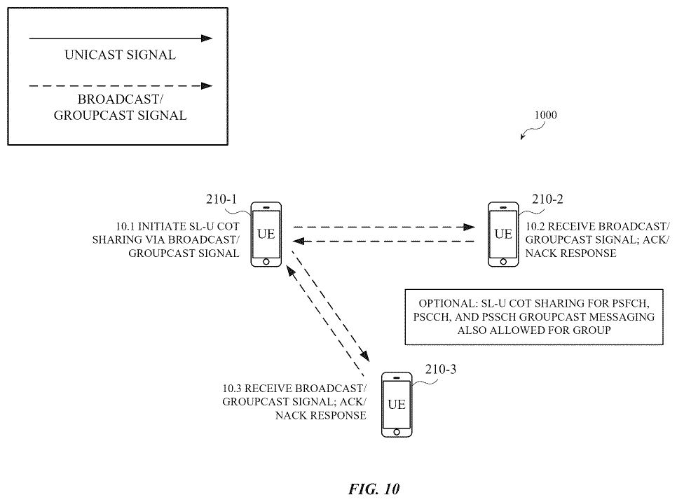

Referring to FIG. 10, UE 210-1 may receive an SL grant (e.g., DG or CG) from base station 222 (not shown). UE 210-1 may initiate SL communications with SL-U COT sharing via broadcast or groupcast signals to UEs 210-2 and 210-3 (at 10.1). UEs 210-2 and 210-3 may receive the broadcast or groupcast signals (at 10.2 and 10.3) and may use the SL-U COT sharing to respond with a hybrid automatic repeat request (HARQ) acknowledgement or negative-acknowledgement (ACK/NACK) message via broadcast or groupcast signaling. In some implementations, only a PSFCH transmission with a HARQ mode 1 and HARQ mode 2 may be transmitted via SL-U COT sharing since the ACK/NACK message may be relayed to base station 222 via UE 210-1. Additionally, the SL-U COT sharing may involve type 2 CCA and/or one shot LBT. A type 2 CCA procedure may include a carrier sense based detection procedure as opposed to, for example, an energy detection (ED) based procedure of type 1 CCA. In some implementations, the SL-U COT sharing initiated by UE 210-1 may be used by any UEs 210 of the same group to groupcast PSFCH, PSCCH, and PSSCH signals.

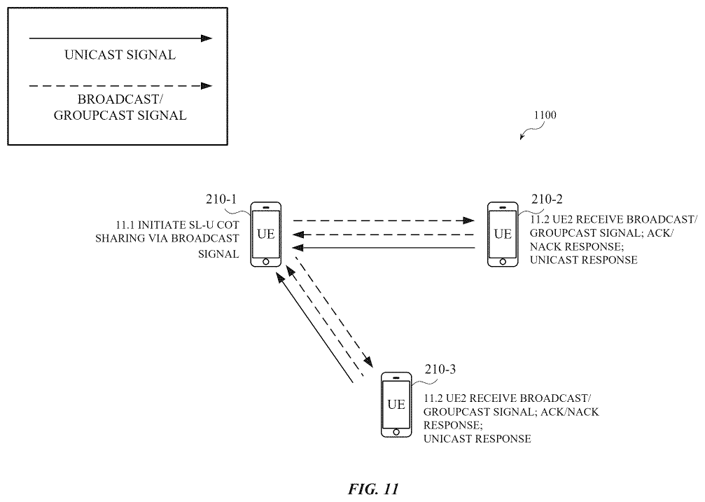

Referring to FIG. 11, UE 210-1 may receive an SL grant (e.g., DG or CG) from base station 222 (not shown). UE 210-1 may initiate SL communications with SL-U COT sharing via broadcast or groupcast signals to UEs 210-2 and 210-3 (at 11.1). UEs 210-2 and 210-3 may receive the broadcast or groupcast signals (at 11.2 and 11.3) and may use the SL-U COT sharing to respond with a HARQ ACK/NACK message via broadcast or groupcast signaling. In some implementations, only a PSFCH with a hybrid automatic repeat request (HARQ) mode 1 and HARQ mode 2 may be transmitted. Additionally, the SL-U COT sharing may involve type 2 CCA and/or one shot LBT. In some implementations, the SL-U COT sharing initiated by UE 210-1 may be used by any UEs 210 of the same group to groupcast PSFCH, PSCCH, and PSSCH signals. Additionally, or alternatively, the SL-U COT sharing initiated by UE 210-1 may enable UEs 210-2 and 210-3 to unicast PSFCH, PSCCH, and PSSCH messaging to UE 210-1. For example, the SL-U COT sharing initiated by UE 210-1 may be used by UEs 210-2 and 210-3 to group cast ACK/NACK messages via a PSFCH and unicast other messages via PSCCH, and PSSCH. Further, while FIGS. 6-11 include several examples of SL-U COT sharing via unicast, broadcast, and groupcast signaling, the techniques described herein also include any combination or variation of the examples of FIGS. 6-11.

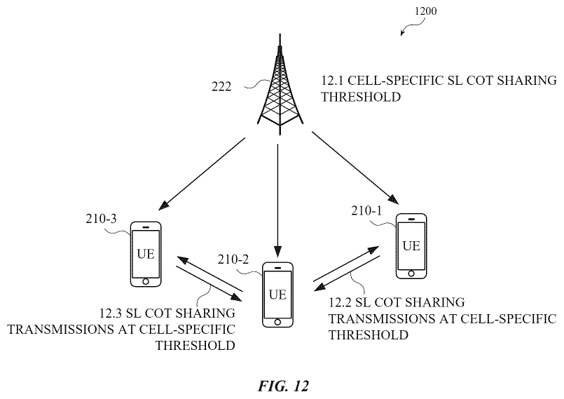

FIGS. 12-14 are diagrams of examples 1200, 1300, and 1400 (collectively referred to as examples 1200-1400) for configuring transmission power thresholds for SL-U COT sharing according to one or more implementations described herein. As shown, examples 1200-1400 may include UEs 210 and base station 222. Communications between UEs 210 and base station 222 may involve the licensed frequency band. Communications between UEs 210 may involve SL-U communications implementing COT sharing. An SL-U COT sharing threshold (or simply “transmission power threshold”) as described herein, may include a maximum transmission power threshold that a UE 210 may use to transmit SL signals.

Examples 1200-1400 may involve a resource selection mode 1 scenario and/or a resource selection mode 2 scenario. In a resource selection mode 1 scenario, base station 222 may be involved in SL resource selection, allocation, and management since, for example, UEs 210 may be within a coverage area of base station 222. In a resource selection mode 2 scenario, UEs 210 may autonomously (e.g., without direct input from base station 222) select and manage SL resources since, for example, one or more of UEs 210 may be outside the coverage area of base station 222. In some implementations, base station 222 may determine a SL-U COT sharing threshold for a UE 210 (e.g., in a mode 1 scenario) and may provide the UE 210 with the SL-U COT sharing threshold as part of a DG or CG transmission. The UE 210 having received the transmission power threshold from base station 222, may provide the SL-U COT sharing threshold to another UE 210 (e.g., in a mode 2 scenario) via SCI. SL communications between the UEs 210 may therefore be in conformity with the SL-U COT sharing threshold.

Referring to FIG. 12, in some implementations, base station 222 may provide a cell-specific SL-U COT sharing threshold, such that each UE 210 receives the same SL-U COT sharing threshold from base station 222 (at 12.1). In such a scenario, UEs 210 may engage in SL communications using the cell-specific SL-U COT sharing threshold (at 12.2 and 12.3).

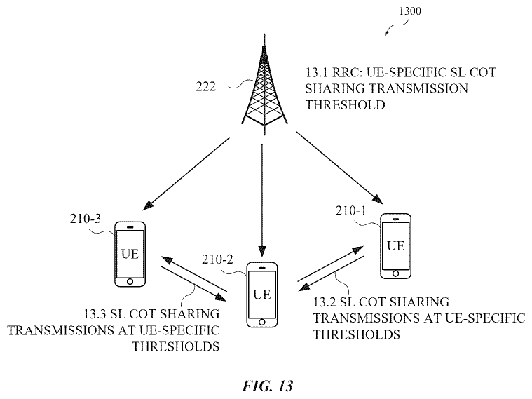

Referring to FIG. 13, in some implementations, base station 222 may also, or alternatively, provide a UE-specific SL-U COT sharing threshold, such that different UEs 210 may receive different SL-U COT sharing thresholds. In such a scenario, each UE 210 may engage in SL communications using cell-specific (e.g., different) SL-U COT sharing thresholds (at 13.2 and 13.3). In some implementations, base station 222 may be configured to provide cell-specific SL-U COT sharing thresholds to certain UEs 210 and UE-specific SL-U COT sharing thresholds to other UEs 210. In such implementations, base station 222 may be configured to determine which type of SL-U COT sharing threshold is suitable for a particular UE 210 based on one or more factors, such as a location of the UE, a signal strength measured by the UE, a stated function or purpose for requested SL resources, etc.

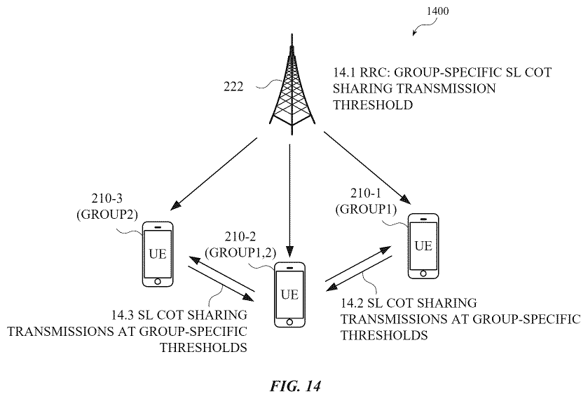

Referring to FIG. 14, in some implementations, base station 222 may also, or alternatively, provide a group-specific SL-U COT sharing threshold, such that UEs 210 of a particular group may receive a SL-U COT sharing threshold that may vary from that of other UE groups, UE-specific thresholds, or cell-specific thresholds. As show for example, UE 210-1 may be part of group 1, UE 210-3 may be part of group 2, and UE 210-3 may be part of group 1 and group 2. In such a scenario, bases station 222 may provide a SL-U COT sharing threshold to UEs 210 according to their group. As depicted, UE 210-1 may communicate with UE 210-2 according to the SL-U COT sharing threshold for group 1; UE 210-3 may communicate with UE 210-2 according to the SL-U COT sharing threshold for group 2; and UE 210-2 may communicate with UE 210-1 and UE 210-3 according to their respective group-specific SL-U COT sharing thresholds. In some implementations, base station 222 may configure group-specific SL-U COT sharing thresholds via RRC messaging. Additionally, or alternatively, a group-specific SL-U COT sharing threshold may be used for groupcast signals and/or unicast signals within a corresponding group.

In some implementations, when the SL-U COT sharing threshold is not configured (e.g., received from base station 222 or from a UE 210 via SL signaling), UE 210 may determine an energy detection threshold (EDT) used in the channel access procedure, for initiating SL-U COT sharing and signal to the other UE 210 via SCI. The transmission power for the shared COT may be limited by the power used to determine the EDT, which may be provided to the other UE via SCI. In some implementations, the higher the Tx power, the tighter may be the Tx threshold, which may result in accessing a channel being more difficult or competitive.

In such a scenario, each UE 210 may engage in SL communications using cell-specific (e.g., different) SL-U COT sharing thresholds (at 13.2 and 13.3). In some implementations, base station 222 may be configured to provide cell-specific SL-U COT sharing thresholds to certain UEs 210 and UE-specific SL-U COT sharing thresholds to other UEs 210. In such implementations, base station 222 may be configured to determine which type of SL-U COT sharing threshold is suitable for a particular UE 210 based on one or more factors, such as a location of the UE, a signal strength measured by the UE, a stated function or purpose for requested SL resources, etc.

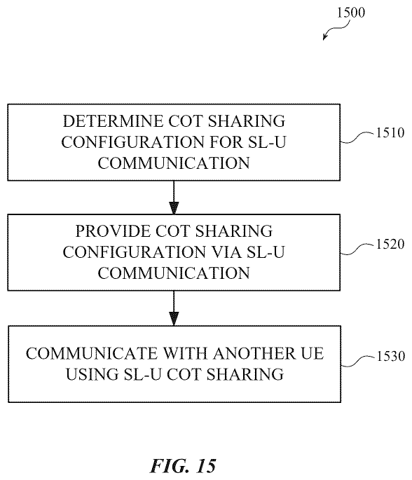

FIG. 15 is a diagram of an example process for SL-U COT sharing according to one or more implementations described herein. Process 1500 may be implemented by UE 210-1, UE 210-2, and base station 222. In some implementations, some or all of process 1500 may be performed by one or more other systems or devices, including one or more of the devices of FIG. 2. Additionally, process 1500 may include one or more fewer, additional, differently ordered and/or arranged operations than those shown in FIG. 15. In some implementations, some or all of the operations of process 1500 may be performed independently, successively, simultaneously, etc., of one or more of the other operations of process 1500. As such, the techniques described herein are not limited to a number, sequence, arrangement, timing, etc., of the operations or process depicted in FIG. 15.

As shown, process 1500 may include determining a COT sharing configuration for SL-U communications (block 1510). For example, UE 210 may determine a COT sharing configuration for SL-U communications with another UE 210. In some implementations, UE 210 may receive and store an SL grant from RAN node 222. The SL grant and/or other configuration information received from RAN node 222 may specify SL signal timing and gaps for SL-U COT sharing. RAN node 222 may also provide UE 210 with information and instructions regarding types of signals (e.g., unicast, broadcast, and groupcast signals) and channels (e.g., PSFCH PSSCH, and PSCCH) that may be used in SL-U COT sharing scenarios. UE 210 may also receive configuration information about maximum transmission power thresholds that UE 210 may use for SL-U COT sharing scenarios. In some implementations, UE 120 may alternatively determine the COT sharing configuration information without a SL grant from RAN node 222.

In such implementations, UE 110 may independently determine appropriate SL communications resources (e.g., SL-U frequency resources, SL-U timing resources, SL-U gap information, a MCOT, a PSFCH, a PSSCH, a PSCCH, etc.). In some implementations, this may include a CCA procedure and/or LBT procedure.

Process 1500 may also include providing the COT sharing configuration via SL-U communications (block 1520). For example, UE 210 may communicate or transmit the COT sharing configuration to one or more other UEs 210 via SL-U resources. In some implementations, this may include a unicast transmission, a groupcast transmission, and/or a broadcast transmission. The COT sharing configuration may be communicated with an invitation to participate in SL communications using the COT sharing configuration.

Process 1500 may include communicating with another UE 210 using the COT sharing configuration (block 1530). For example, in response to providing a COT sharing configuration, the Tx UE 210 may receive a corresponding response from one or more Rx UEs 210. In turn, the Tx UE 210 and Rx UEs 110 may engage in SL communications using the COT sharing configuration. In some implementations, the SL communications using the COT sharing configuration may continue until a UE 110 terminates the SL communications, expiration of the MCOT, etc.

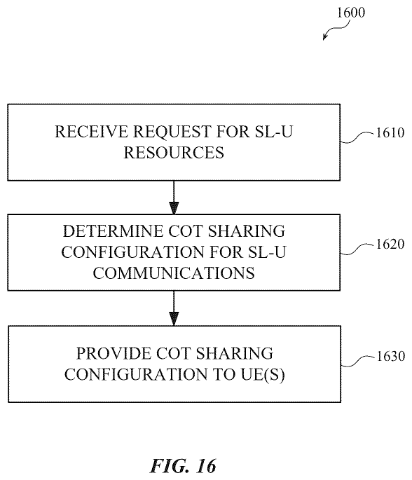

FIG. 16 is a diagram of an example process for configuring transmitting power thresholds for SL-U COT sharing according to one or more implementations described herein.

Process 1600 may be implemented by UE 210-1, UE 210-2, and base station 222. In some implementations, some or all of process 1600 may be performed by one or more other systems or devices, including one or more of the devices of FIG. 2. Additionally, process 1600 may include one or more fewer, additional, differently ordered and/or arranged operations than those shown in FIG. 16. In some implementations, some or all of the operations of process 1600 may be performed independently, successively, simultaneously, etc., of one or more of the other operations of process 1600. As such, the techniques described herein are not limited to a number, sequence, arrangement, timing, etc., of the operations or process depicted in FIG. 16.

As shown, process 1600 may include receiving a request for SL-U communications (block 1610). For example, base station 222 may receive a request from UE 210 for SL-U resources. In some implementations, the request may be a request for a DG request for SL-U resources. In some implementations, base station 222 may perform one or more of the operations of process 1600 (e.g., blocks 1620 and 1630) without receiving a request for SL-U resources. In such implementations, baes station 222 may provide UE 210 with a CG, which may include a COT sharing configuration for SL-U communications.

Process 1600 may include determining a COT sharing configuration for SL-U communications. For example, base station 222 may determine a COT sharing configuration to enable UEs 210 to communicate with one another via SL-U. The COT sharing configuration may include one or more communication gaps, a MCOT, SL signaling and channel information, etc. In some implementations, the COT sharing configuration may be UE-specific, cell-specific, or specific to a group of UEs 210. In some implementations, the COT sharing configuration may be determine along with one or more other types of SL resources, such as SL-U frequency resources, SL-U timing resources, a PSFCH, a PSSCH, a PSCCH, a CCA procedure, CP extension information, etc.

Process 1600 may include providing the COT sharing configuration to one or more UEs 210. For example, base station 222 may communication the COT sharing configuration to one or more UEs 210. The COT sharing configuration may be communicated along with other types of information (e.g., an SL resource grant). In some implementations, base station 222 may provide the COT sharing configuration via a PDCCH.

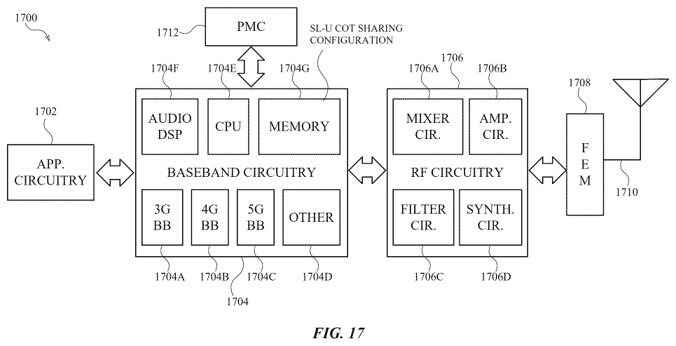

FIG. 17 is a diagram of an example of components of a device according to one or more implementations described herein. In some implementations, the device 1700 can include application circuitry 1702, baseband circuitry 1704, RF circuitry 1706, front-end module (FEM) circuitry 1708, one or more antennas 1710, and power management circuitry (PMC) 1712 coupled together at least as shown. The components of the illustrated device 1700 can be included in a UE or a RAN node. In some implementations, the device 1700 can include fewer elements (e.g., a RAN node may not utilize application circuitry 1702, and instead include a processor/controller to process IP data received from a CN or an Evolved Packet Core (EPC)). In some implementations, the device 1700 can include additional elements such as, for example, memory/storage, display, camera, sensor (including one or more temperature sensors, such as a single temperature sensor, a plurality of temperature sensors at different locations in device 1700, etc.), or input/output (I/O) interface. In other implementations, the components described below can be included in more than one device (e.g., said circuitries can be separately included in more than one device for Cloud-RAN (C-RAN) implementations).

The application circuitry 1702 can include one or more application processors. For example, the application circuitry 1702 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 1700. In some implementations, processors of application circuitry 1702 can process IP data packets received from an EPC.

The baseband circuitry 1704 can include circuitry such as, but not limited to, one or more single-core or multi-core processors. The baseband circuitry 1704 can include one or more baseband processors or control logic to process baseband signals received from a receive signal path of the RF circuitry 1706 and to generate baseband signals for a transmit signal path of the RF circuitry 1706. Baseband circuity 1704 can interface with the application circuitry 1702 for generation and processing of the baseband signals and for controlling operations of the RF circuitry 1706. For example, in some implementations, the baseband circuitry 1704 can include a 3G baseband processor 1704A, a 4G baseband processor 1704B, a 5G baseband processor 1704C, or other baseband processor(s) 1704D for other existing generations, generations in development or to be developed in the future (e.g., 5G, 6G, etc.). The baseband circuitry 1704 (e.g., one or more of baseband processors 1704A-D) can handle various radio control functions that enable communication with one or more radio networks via the RF circuitry 1706. In other implementations, some or all of the functionality of baseband processors 1704A-D can be included in modules stored in the memory 1704G and executed via a Central Processing Unit (CPU) 1704E. The radio control functions can include, but are not limited to, signal modulation/demodulation, encoding/decoding, radio frequency shifting, etc. In some implementations, modulation/demodulation circuitry of the baseband circuitry 1704 can include Fast-Fourier Transform (FFT), precoding, or constellation mapping/de-mapping functionality. In some implementations, encoding/decoding circuitry of the baseband circuitry 1704 can include convolution, tail-biting convolution, turbo, Viterbi, or Low-Density Parity Check (LDPC) encoder/decoder functionality. Implementations of modulation/demodulation and encoder/decoder functionality are not limited to these examples and can include other suitable functionality in other implementations.

In some implementations, memory 1704G may receive and store an SL grant from RAN node 222. The SL grant and/or other configuration information received from RAN node 222 may specify SL signal timing and gaps for SL-U COT sharing with one or more other UEs 210. RAN node 222 may also provide UE 210 with information and instructions regarding types of signals (e.g., unicast, broadcast, and groupcast signals) and channels (e.g., PSFCH PSSCH, and PSCCH) that may be used in SL-U COT sharing scenarios. UE 210 may also receive configuration information about maximum transmission power thresholds that UE 210 may use for SL-U COT sharing scenarios.

In some implementations, the baseband circuitry 1704 can include one or more audio digital signal processor(s) (DSP) 1704F. The audio DSPs 1704F can include elements for compression/decompression and echo cancellation and can include other suitable processing elements in other implementations. Components of the baseband circuitry can be suitably combined in a single chip, a single chipset, or disposed on a same circuit board in some implementations. In some implementations, some or all of the constituent components of the baseband circuitry 1704 and the application circuitry 1702 can be implemented together such as, for example, on a system on a chip (SOC).

In some implementations, the baseband circuitry 1704 can provide for communication compatible with one or more radio technologies. For example, in some implementations, the baseband circuitry 1704 can support communication with a NG-RAN, an evolved universal terrestrial radio access network (EUTRAN) or other wireless metropolitan area networks (WMAN), a wireless local area network (WLAN), a wireless personal area network (WPAN), etc. Implementations in which the baseband circuitry 1704 is configured to support radio communications of more than one wireless protocol can be referred to as multi-mode baseband circuitry.

RF circuitry 1706 can enable communication with wireless networks using modulated electromagnetic radiation through a non-solid medium. In various implementations, the RF circuitry 1706 can include switches, filters, amplifiers, etc. to facilitate the communication with the wireless network. RF circuitry 1706 can include a receive signal path which can include circuitry to down-convert RF signals received from the FEM circuitry 1708 and provide baseband signals to the baseband circuitry 1704. RF circuitry 1706 can also include a transmit signal path which can include circuitry to up-convert baseband signals provided by the baseband circuitry 1704 and provide RF output signals to the FEM circuitry 1708 for transmission.

In some implementations, the receive signal path of the RF circuitry 1706 can include mixer circuitry 1706A, amplifier circuitry 1706B and filter circuitry 1706C. In some implementations, the transmit signal path of the RF circuitry 1706 can include filter circuitry 1706C and mixer circuitry 1706A. RF circuitry 1706 can also include synthesizer circuitry 1706D for synthesizing a frequency for use by the mixer circuitry 1706A of the receive signal path and the transmit signal path. In some implementations, the mixer circuitry 1706A of the receive signal path can be configured to down-convert RF signals received from the FEM circuitry 1708 based on the synthesized frequency provided by synthesizer circuitry 1706D. The amplifier circuitry 1706B can be configured to amplify the down-converted signals and the filter circuitry 1706C can be a low-pass filter (LPF) or band-pass filter (BPF) configured to remove unwanted signals from the down-converted signals to generate output baseband signals. Output baseband signals can be provided to the baseband circuitry 1704 for further processing. In some implementations, the output baseband signals can be zero-frequency baseband signals, although this is not a requirement. In some implementations, mixer circuitry 1706A of the receive signal path can comprise passive mixers, although the scope of the implementations is not limited in this respect.

In some implementations, the mixer circuitry 1706A of the transmit signal path can be configured to up-convert input baseband signals based on the synthesized frequency provided by the synthesizer circuitry 1706D to generate RF output signals for the FEM circuitry 1708. The baseband signals can be provided by the baseband circuitry 1704 and can be filtered by filter circuitry 1706C.

In some implementations, the mixer circuitry 1706A of the receive signal path and the mixer circuitry 1706A of the transmit signal path can include two or more mixers and can be arranged for quadrature down conversion and up conversion, respectively. In some implementations, the mixer circuitry 1706A of the receive signal path and the mixer circuitry 1706A of the transmit signal path can include two or more mixers and can be arranged for image rejection (e.g., Hartley image rejection). In some implementations, the mixer circuitry 1706A of the receive signal path and the mixer circuitry 1706A can be arranged for direct down conversion and direct up conversion, respectively. In some implementations, the mixer circuitry 1706A of the receive signal path and the mixer circuitry 1706A of the transmit signal path can be configured for super-heterodyne operation.

In some implementations, the output baseband signals, and the input baseband signals can be analog baseband signals, although the scope of the implementations is not limited in this respect. In some alternate implementations, the output baseband signals, and the input baseband signals can be digital baseband signals. In these alternate implementations, the RF circuitry 1706 can include analog-to-digital converter (ADC) and digital-to-analog converter (DAC) circuitry and the baseband circuitry 1704 can include a digital baseband interface to communicate with the RF circuitry 1706.

In some dual-mode implementations, a separate radio IC circuitry can be provided for processing signals for each spectrum, although the scope of the implementations is not limited in this respect.

In some implementations, the synthesizer circuitry 1706D can be a fractional-N synthesizer or a fractional N/N+1 synthesizer, although the scope of the implementations is not limited in this respect as other types of frequency synthesizers can be suitable. For example, synthesizer circuitry 1706D can be a delta-sigma synthesizer, a frequency multiplier, or a synthesizer comprising a phase-locked loop with a frequency divider.

The synthesizer circuitry 1706D can be configured to synthesize an output frequency for use by the mixer circuitry 1706A of the RF circuitry 1706 based on a frequency input and a divider control input. In some implementations, the synthesizer circuitry 1706D can be a fractional N/N+1 synthesizer.

In some implementations, frequency input can be provided by a voltage-controlled oscillator (VCO), although that is not a requirement. Divider control input can be provided by either the baseband circuitry 1704 or the applications circuitry 1702 depending on the desired output frequency. In some implementations, a divider control input (e.g., N) can be determined from a look-up table based on a channel indicated by the applications circuitry 1702.

Synthesizer circuitry 1706D of the RF circuitry 1706 can include a divider, a delay-locked loop (DLL), a multiplexer and a phase accumulator. In some implementations, the divider can be a dual modulus divider (DMD) and the phase accumulator can be a digital phase accumulator (DPA). In some implementations, the DMD can be configured to divide the input signal by either N or N+1 (e.g., based on a carry out) to provide a fractional division ratio. In some example implementations, the DLL can include a set of cascaded, tunable, delay elements, a phase detector, a charge pump and a D-type flip-flop. In these implementations, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some implementations, synthesizer circuitry 1706D can be configured to generate a carrier frequency as the output frequency, while in other implementations, the output frequency can be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some implementations, the output frequency can be a LO frequency (fLO). In some implementations, the RF circuitry 1706 can include an IQ/polar converter.

FEM circuitry 1708 can include a receive signal path which can include circuitry configured to operate on RF signals received from one or more antennas 1710, amplify the received signals and provide the amplified versions of the received signals to the RF circuitry 1706 for further processing. FEM circuitry 1708 can also include a transmit signal path which can include circuitry configured to amplify signals for transmission provided by the RF circuitry 1706 for transmission by one or more of the one or more antennas 1710. In various implementations, the amplification through the transmit or receive signal paths can be done solely in the RF circuitry 1706, solely in the FEM circuitry 1708, or in both the RF circuitry 1706 and the FEM circuitry 1708.

In some implementations, the FEM circuitry 1708 can include a TX/RX switch to switch between transmit mode and receive mode operation. The FEM circuitry can include a receive signal path and a transmit signal path. The receive signal path of the FEM circuitry can include an LNA to amplify received RF signals and provide the amplified received RF signals as an output (e.g., to the RF circuitry 1706). The transmit signal path of the FEM circuitry 1708 can include a power amplifier (PA) to amplify input RF signals (e.g., provided by RF circuitry 1706), and one or more filters to generate RF signals for subsequent transmission (e.g., by one or more of the one or more antennas 1710).

In some implementations, the PMC 1712 can manage power provided to the baseband circuitry 1704. In particular, the PMC 1712 can control power-source selection, voltage scaling, battery charging, or DC-to-DC conversion. The PMC 1712 can often be included when the device 1700 is capable of being powered by a battery, for example, when the device is included in a UE. The PMC 1712 can increase the power conversion efficiency while providing desirable implementation size and heat dissipation characteristics.

While FIG. 17 shows the PMC 1712 coupled only with the baseband circuitry 1704. However, in other implementations, the PMC 1712 may be additionally or alternatively coupled with, and perform similar power management operations for, other components such as, but not limited to, application circuitry 1702, RF circuitry 1706, or FEM circuitry 1708.

In some implementations, the PMC 1712 can control, or otherwise be part of, various power saving mechanisms of the device 1700. For example, if the device 1700 is in an RRC_Connected state, where it is still connected to the RAN node as it expects to receive traffic shortly, then it can enter a state known as Discontinuous Reception Mode (DRX) after a period of inactivity. During this state, the device 1700 can power down for brief intervals of time and thus save power.

If there is no data traffic activity for an extended period of time, then the device 1700 can transition off to an RRC_Idle state, where it disconnects from the network and does not perform operations such as channel quality feedback, handover, etc. The device 1700 goes into a very low power state and it performs paging where again it periodically wakes up to listen to the network and then powers down again. The device 1700 may not receive data in this state; in order to receive data, it can transition back to RRC_Connected state.

An additional power saving mode can allow a device to be unavailable to the network for periods longer than a paging interval (ranging from seconds to a few hours). During this time, the device is unreachable to the network and can power down completely. Any data sent during this time incurs a large delay and it is assumed the delay is acceptable.

Processors of the application circuitry 1702 and processors of the baseband circuitry 1704 can be used to execute elements of one or more instances of a protocol stack. For example, processors of the baseband circuitry 1704, alone or in combination, can be used execute Layer 3, Layer 2, or Layer 1 functionality, while processors of the baseband circuitry 1704 can utilize data (e.g., packet data) received from these layers and further execute Layer 4 functionality (e.g., transmission communication protocol (TCP) and user datagram protocol (UDP) layers). As referred to herein, Layer 3 can comprise a RRC layer, described in further detail below. As referred to herein, Layer 2 can comprise a medium access control (MAC) layer, a radio link control (RLC) layer, and a packet data convergence protocol (PDCP) layer, described in further detail below. As referred to herein, Layer 1 can comprise a physical (PHY) layer of a UE/RAN node, described in further detail below.

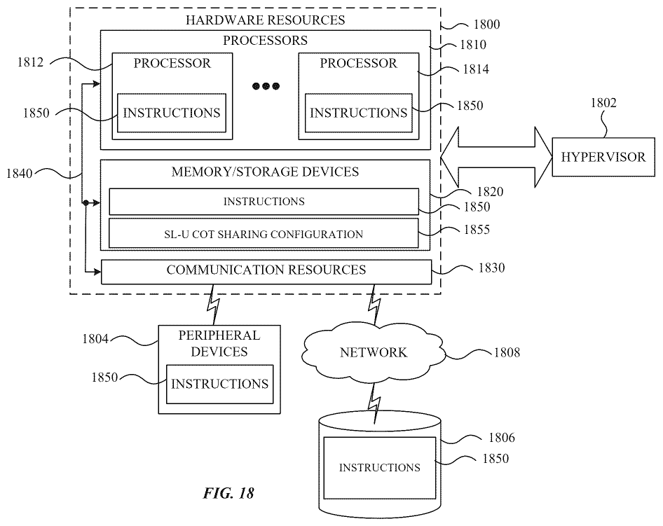

FIG. 18 is a block diagram illustrating components, according to some example implementations, able to read instructions from a machine-readable or computer-readable medium (e.g., a non-transitory machine-readable storage medium) and perform any one or more of the methodologies discussed herein. Specifically, FIG. 18 shows a diagrammatic representation of hardware resources 1800 including one or more processors (or processor cores) 1810, one or more memory/storage devices 1820, and one or more communication resources 1830, each of which may be communicatively coupled via a bus 1840. For implementations where node virtualization (e.g., NFV) is utilized, a hypervisor may be executed to provide an execution environment for one or more network slices/sub-slices to utilize the hardware resources 1800 The processors 1810 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 1812 and a processor 1814.

The memory/storage devices 1820 may include main memory, disk storage, or any suitable combination thereof. The memory/storage devices 1820 may include, but are not limited to any type of volatile or non-volatile memory such as dynamic random-access memory (DRAM), static random-access memory (SRAM), erasable programmable read-only memory (EPROM), electrically erasable programmable read-only memory (EEPROM), Flash memory, solid-state storage, etc.

In some implementations, memory/storage devices 1820 may receive and store an SL grant from RAN node 222. The SL grant and/or other configuration information received from RAN node 222 may specify SL signal timing and gaps for SL-U COT sharing with one or more other UEs 210. RAN node 222 may also provide UE 210 with information and instructions regarding types of signals (e.g., unicast, broadcast, and groupcast signals) and channels (e.g., PSFCH PSSCH, and PSCCH) that may be used in SL-U COT sharing scenarios. UE 210 may also receive configuration information about maximum transmission power thresholds that UE 210 may use for SL-U COT sharing scenarios.

The communication resources 1830 may include interconnection or network interface components or other suitable devices to communicate with one or more peripheral devices 1804 or one or more databases 1806 via a network 1808. For example, the communication resources 1830 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 1850 may comprise software, a program, an application, an applet, an app, or other executable code for causing at least any of the processors 1810 to perform any one or more of the methodologies discussed herein. The instructions 1850 may reside, completely or partially, within at least one of the processors 1810 (e.g., within the processor's cache memory), the memory/storage devices 1820, or any suitable combination thereof. Furthermore, any portion of the instructions 1850 may be transferred to the hardware resources 1800 from any combination of the peripheral devices 1804 or the databases 1806. Accordingly, the memory of processors 1810, the memory/storage devices 1820, the peripheral devices 1804, and the databases 1806 are examples of computer-readable and machine-readable media.

Examples herein can include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

In example 1, which may also include one or more of the example described herein, a user equipment (UE), may comprise: a memory; and one or more processors configured to, when executing instructions stored in the memory, cause the UE to: transmit an SL unlicensed spectrum (SL-U) channel occupancy time (COT) sharing configuration to one or more other UEs to initiate sidelink (SL) communications with the one or more other UEs; receive, from the one or more other UEs, a response in accordance with the SL-U COT sharing configuration; and communicate, with the one or more other UEs, based on the SL-U COT sharing configuration.

In example 2, which may also include one or more of the example described herein, the SL-U COT sharing configuration comprises a gap between UE transmissions of less than 16 microseconds (μs), 16 μs, or 25 μs.

In example 3, which may also include one or more of the example described herein, the SL-U COT sharing configuration comprises a gap between UE transmissions of less than 25 μs.

In example 4, which may also include one or more of the example described herein, the SL-U COT sharing configuration comprises a gap between UE transmissions of any length less than a maximum COT (MCOT).

In example 5, which may also include one or more of the example described herein, the one or more other UEs is limited to UEs that received and responded to the SL-U COT sharing configuration directly from the UE via unicast.

In example 6, which may also include one or more of the example described herein, the one or more other UEs is limited to UEs that received and responded to the SL-U COT sharing configuration directly from the UE via broadcast.

In example 7, which may also include one or more of the example described herein, the one or more other UEs is limited to UEs that received and responded to the SL-U COT sharing configuration directly from the UE via groupcast.

In example 8, which may also include one or more of the example described herein, the one or more other UEs comprise UEs that receive, directly or indirectly through another UE, the SL-U COT sharing configuration originating from the UE.

In example 9, which may also include one or more of the example described herein, the SL-U COT sharing configuration is provided via broadcast or groupcast.

In example 10, which may also include one or more of the example described herein, the SL-U COT sharing configuration comprises a transmission power threshold for SL-U COT sharing communications.

In example 11, which may also include one or more of the example described herein, the transmission power threshold is at least one of: cell-specific, UE-specific, UE-group specific, or determined autonomously by the UE.

In example 12, which may also include one or more of the example described herein, a method, performed by a user equipment (UE), may comprise: transmitting an sidelink (SL) unlicensed spectrum (SL-U) channel occupancy time (COT) sharing configuration to one or more other UEs to initiate SL communications with the one or more other UEs; receiving, from the one or more other UEs, a response in accordance with the SL-U COT sharing configuration; and communicating, with the one or more other UEs, based on the SL-U COT sharing configuration.

In example 13, which may also include one or more of the example described herein, a computer-readable medium may comprise: instructions that when executed by one or more processors cause the one or more processors to: transmit an SL unlicensed spectrum (SL-U) channel occupancy time (COT) sharing configuration to one or more other UEs to initiate sidelink (SL) communications with the one or more other UEs; receive, from the one or more other UEs, a response in accordance with the SL-U COT sharing configuration; and communicate, with the one or more other UEs, based on the SL-U COT sharing configuration.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context may indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled to minimize risks of unintentional or unauthorized access or use, and the nature of authorized use should be clearly indicated to users.

1-20. (canceled)

21. A user equipment (UE), comprising:
radio frequency (RF) circuitry;
a memory; and
one or more processors configured to, when executing instructions stored in the memory, cause the UE to:
transmit, via the RF circuitry, sidelink (SL) channel occupancy time (COT) sharing information to one or more other UEs to initiate SL communications with the one or more other UEs;
receive, from the one or more other UEs, a response in accordance with the SL COT sharing information; and
communicate with the one or more other UEs based on the SL COT sharing information.

22. The UE of claim 21, wherein the SL COT sharing information is included in sidelink control information (SCI).

23. The UE of claim 21, wherein the one or more processors further cause the UE to:
receive SL COT sharing information for a channel from another UE; and
perform a listen before talk (LBT) procedure before communicating on the channel based on whether a gap length is less than 16 microseconds (μs).

24. The UE of claim 21, wherein the SL COT sharing information comprises a gap between UE transmissions of any length less than a maximum COT (MCOT).

25. The UE of claim 21, wherein the one or more other UEs is limited to UEs that received and responded to the SL COT sharing information directly from the UE via unicast.

26. The UE of claim 21, wherein the one or more other UEs is limited to UEs that received and responded to the SL COT sharing information directly from the UE via broadcast.

27. The UE of claim 21, wherein the one or more other UEs is limited to UEs that received and responded to the SL COT sharing information directly from the UE via groupcast.

28. The UE of claim 21, wherein the one or more other UEs comprise UEs that receive, directly or indirectly through another UE, the SL COT sharing information originating from the UE.

29. The UE of claim 28, wherein the SL COT sharing information is provided via broadcast or groupcast.

30. The UE of claim 21, wherein the SL COT sharing information comprises a transmission power threshold for SL COT sharing communications.

31. The UE of claim 30, wherein the transmission power threshold is at least one of:
cell-specific,
UE-specific,
UE-group specific, or
determined autonomously by the UE.

32. A method for a user equipment (UE), comprising:
transmitting sidelink (SL) channel occupancy time (COT) sharing information to one or more other UEs to initiate SL communications with the one or more other UEs;
receiving, from the one or more other UEs, a response in accordance with the SL COT sharing information; and
communicating with the one or more other UEs based on the SL COT sharing information.

33. The method of claim 32, wherein the SL COT sharing information comprises a gap between UE transmissions of less than 16 microseconds (μs), 16 μs, or 25 μs.

34. The method of claim 32, wherein the SL COT sharing information comprises a gap between UE transmissions of less than 25 μs.

35. The method of claim 32, wherein the SL COT sharing information comprises a gap between UE transmissions of any length less than a maximum COT (MCOT).

36. The method of claim 32, wherein the one or more other UEs is limited to UEs that received and responded to the SL COT sharing information directly from the UE via unicast.

37. The method of claim 32, wherein the one or more other UEs is limited to UEs that received and responded to the SL COT sharing information directly from the UE via broadcast.

38. A baseband processor configured to, when executing instructions stored in a memory, perform operations comprising:
providing, to a radio frequency (RF) interface for transmission, sidelink (SL) channel occupancy time (COT) sharing information to one or more user equipments (UEs) to initiate SL communications with the one or more UEs;
receiving, from the one or more UEs, a response in accordance with the SL COT sharing information ; and
communicating with the one or more UEs based on the SL COT sharing information.

39. The baseband processor of claim 38, wherein the SL COT sharing information comprises a gap between UE transmissions of less than 16 microseconds (μs), 16 μs, or 25 μs.

40. The baseband processor of claim 38, wherein the SL COT sharing information comprises a gap between UE transmissions of less than 25 μs.
